(19) United States
(12) Patent Application Publication
(10) Pub. No.: US 2003/0180610 A1
(43) Pub. Date: Sep. 25, 2003

(54) Electrochemically activable layer or film

(76) Inventors: Ulf Zum Felde, Itzehoe (DE); Gerold Neumann, Halstenbek (DE); Peter Gulde, Itzehoe (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/380,638

(22) PCT Filed: Sep. 6, 2001
(86) PCT No.: PCT/EP01/10293

(30) Foreign Application Priority Data
Sep. 14, 2000 (DE) 100 45 561.1
Jan. 12, 2001 (DE) 101 01 299.3

(51) Int. Cl. H01M 4/62; H01M 2/08

(52) U.S. Cl. 429/217; 429/176; 429/185

(57) ABSTRACT

The invention relates to an electrochemically activable layer or film for use in electrochemical components. Said layer or film comprises a textile fabric and a substance which is located at least in the intermediate spaces in said textile fabric, consisting of at least one matrix containing or consisting of an organic polymer, precursors thereof or prepolymers thereof and an electrochemically activable inorganic material which is insoluble in the matrix, in the form of a solid substance. The invention also relates to layered composites and to rechargeable electrochemical cells which are constructed with layers or films of this type, and to a number of methods for producing said layers or films.

The present invention is directed to an improvement of films with electrochemical properties from which composite layers may be produced, said composite layers being suitable as accumulators, electrochromic indicating elements or the like. Specifically, the invention is directed to rechargeable electrochemical cells based on solid components.

Since the beginning of the 1970's there have been attempts to produce electrochemical elements such as accumulators or the like in the form of thin layers. The goal has been to obtain composite films that are both flexible enough that they can be, for instance, rolled up or made to conform to another desired shape and that also have particularly good charging and discharging properties due to an extremely high contact area between the individual electrochemical components, such as electrodes and electrolytes, relative to the volume of active electrochemical material used.

For the production of electrode materials and composite layers of this kind, various attempts have been made.

U.S. Pat. No. 5,456,000 describes rechargeable battery cells that are produced by laminating electrode and electrolyte films. Used for the positive electrode is a film or membrane that is produced separately from LiMn₂O₄ powder in a matrix solution made of a copolymer and is then dried. The negative electrode comprises a dried coating of a pulverized carbon dispersion in a matrix solution of a copolymer. An electrolyte/separator membrane is arranged between the electrode layers. For this purpose a poly(vinylidene fluoride)-hexafluoropropylene copolymer is converted with an organic plasticizer such as propylene carbonate or ethylene carbonate. A film is produced from these components and then the plasticizer is extracted from the layer. The battery cell is maintained in this “inactive” condition until it is to be used. In order to activate it, it is immersed in a suitable electrolyte solution, whereby the cavities formed by extracting the plasticizer are filled with the liquid electrolytes. The battery is then ready for use.

Such a construct is disadvantageous in that the battery cannot be maintained for extended periods in a charged condition because corrosion occurs at the limit surfaces (see communication by A. Blyr et. al., 4th Euroconference on Solid State Ionics, Connemara, Ireland, September 1997). Moreover, the process of expelling plasticizer using a suitable solvent is expensive and problematic; for example, a partial delamination may be envisaged. Specifically, the washing step requires a metallic grid (copper or aluminum, respectively) as the lead electrode rather than a metal film in order to enable the solvent to fully penetrate the battery body. These gauzes or nettings are mechanically very delicate and have to be pretreated in order to obtain a good adhesion to the electrode material. Pretreatment methods of gauzes or nettings have been described for example in U.S. Pat. No. 6,007,588.

One way to avoid the washing process is shown in DE 198 39 217 A1. Here, the formation of an electrolyte film is described using solid electrolyte materials having high ionic conductivity. These are incorporated into a polymer matrix yielding a heterogeneous mixture brought into films. With this procedure, activation of the electrolyte is unnecessary in principle, but it may be required to incorporate a second electrolyte via a liquid phase into the battery body in order to improve the electrical properties of the cells thus prepared, said second electrolyte being at least present at the grain limits of the active material.

Furthermore, there have been attempts to use solid electrolytes in the form of ion-conducting organic polymer electrolytes. Thus, U.S. Pat. No. 5,009,970 describes use of a gel product that is obtained by converting a solid poly(ethylene oxide) polymer with lithium perchlorate and then irradiating it. U.S. Pat. No. 5,041,346 describes an oxymethylene cross-linked variant of these polymer electrolytes that also contains a softener that preferably has ion-solvating properties, for example, that can be a dipolar aprotic solvent such as γ-butyrolactone. However, it has been reported that although the ion conductivity compared to pure solid lithium salt is drastically elevated, it is still not sufficient for use as an electrolyte layer in electrochemical elements.

Common to all these attempts for a solution is the fact that polymer based binders in large amounts have to be incorporated into the pastes which are required as the starting products for the formation of films, in order to obtain tear-proof films which can be further processed. Depending on the technology, significant amounts of plasticizer are partly further added, which are not only water-attracting but also result in signs of aging like brittleness, upon extended storage. Moreover, the binders are an essentially electrochemically inactive material which reduces the energy density of the electrochemical element which is dependent on the amount of active material. Thus, for the advantages of the film processing, a price has to be paid in that the energy density is partially reduced. The examples in the above-mentioned patents illustrate that the amount of the polymeric binders and/or of the plasticizers is in general markedly above 20 percent by weight. The percentage contents by volume in the films are even significantly higher. However, mechanically stable films may be prepared using such compositions.

The problem of the present invention consists in the provision of mechanically stable, preferably self-supporting layers (“films”) having good properties for their further processing, the layers being intended for the preparation of composite layers which may be used as accumulators, electrochromic indicating elements, or the like which lack the disadvantages resulting from high contents of organic polymer material and plasticizer, respectively.

In particular, the inventive layers and films and the composite layers with electrochemical properties produced therefrom, respectively, should provide products such as rechargeable batteries (accumulators), electrochromic components or the like, that have a high degree of flexibility and very good electron- and ion-conducting properties.

This problem is solved by incorporating pastes having relatively low contents of binder/plasticizer into a preferably flexible textile sheet. By this measure, the sheet provides mechanical stability of the films. Due to the moveability of the fibers of which the sheet consists, the mechanical flexibility of the layers is not adversely affected.

Consequently, the invention provides an electrochemically activatable layer or film for use in electrochemical components comprising a textile sheet and a mass made of a matrix containing or consisting of at least one organic polymer, precursors thereof, or prepolymers thereof and an electrochemically activatable inorganic material that is not soluble in said matrix and that is in the form of a solid substance, the mass being present at least in the spaces or gaps of the textile sheet.

The term “that can be used in electrochemical structural elements” or “that can be used in electrochemical components” implies that the electrochemically activatable inorganic material that is in the form of a solid substance must be an ion-conducting or an electron-conducting material that is suitable as an electrode material or as a solid electrolyte or the like in a respective electrochemical structural element or component.

According to the invention, the expression “textile sheet” shall mean any object which can be prepared using textile fibers and having a flat shape. Textile fibers comprise natural fibers (vegetable and animal fibers), so-called chemical or synthetic fibers of substantially organic polymers as well as any other fiber which may be industrially prepared, i.e. fibers made of glass, ceramics, metal, minerals or carbon. As for additional information, reference is made to the definition in Römpp's Chemielexikon, 8^{th} edition, Franck'sche Verlagshandlung Stuttgart (1988), wherein under the head note “textiles”, examples are given, also for sheet-like objects, i.e. felts, woven fabrics and non-wovens (fleeces).

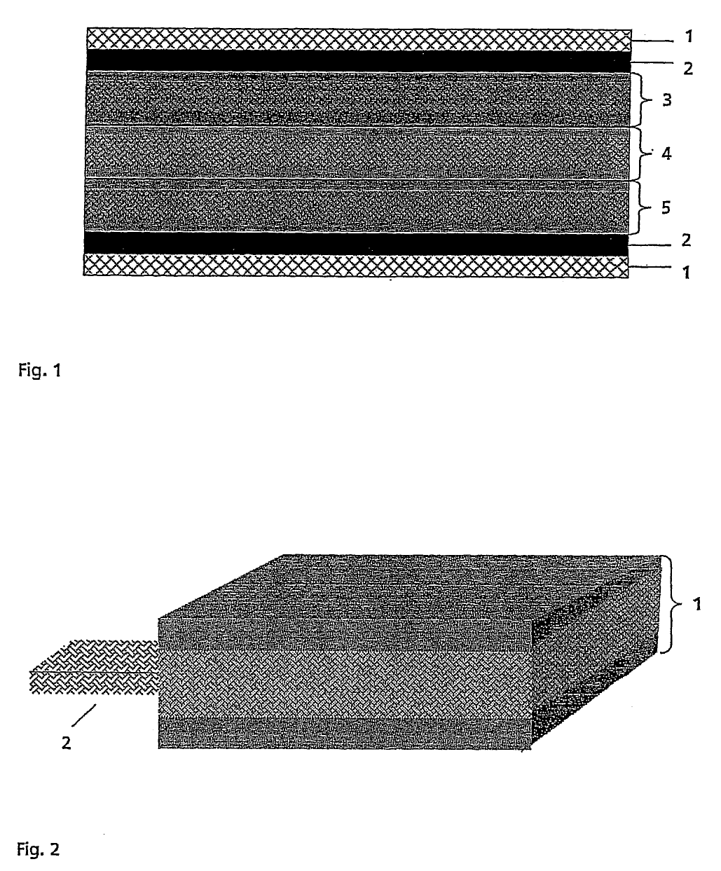

FIG. 1 shows the sequence of a composite layer according to the present invention, wherein both the electrodes and the eletrolyte are embedded in a woven fabric.

FIG. 2 shows an electrode film having a metallized woven fabric embedded therein.

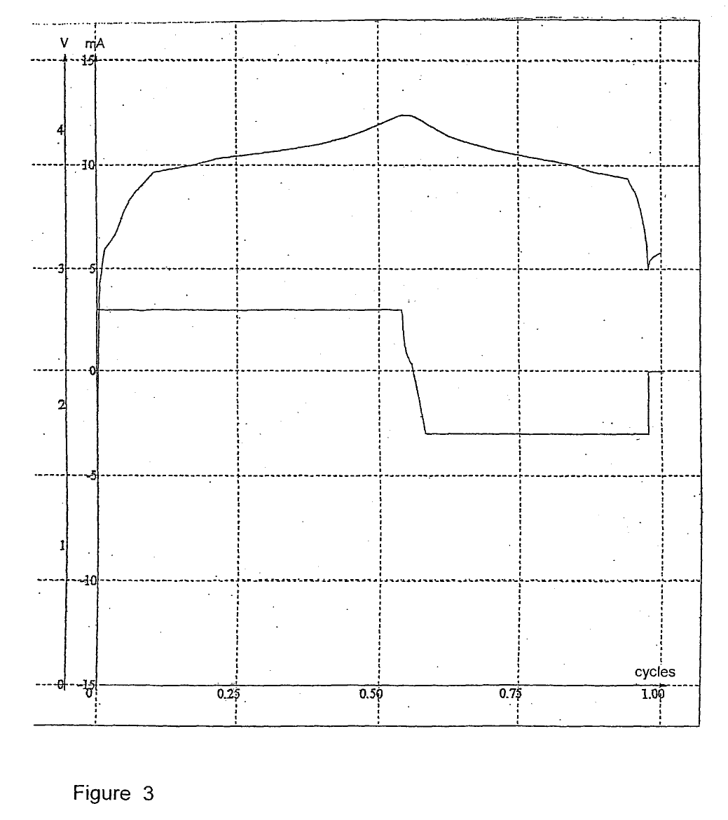

FIG. 3 shows a charge and discharge curve of a lithium accumulator according to Example 4.

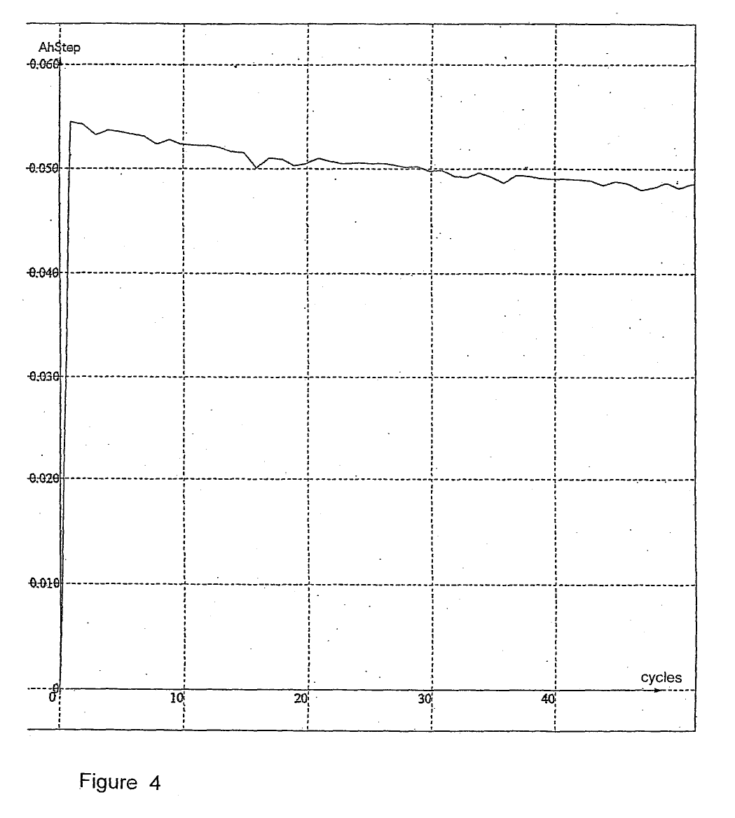

FIG. 4 shows the decrease of the initial capacity of this cell in reference to the increasing number of the charge-discharge steps (number of cycles).

Suitable for the present invention are textile sheets having the shape of woven fabrics which are well adapted to their environment in the electrochemical component in respect to their mechanical behaviour and their moveability. Specifically, in respect to lithium accumulators having intercalation electrodes which undergo permanent expansion and contraction during electric operation, an increased service life, i.e. an increased cycle stabilty, is obtained. Instead of having the shape of a woven fabric, the fibers of the textile sheet may of course also be present in other forms, for example laid into the form of a non-woven or fleece or the like, knitted or composed into a flat textile sheet by way of other methods.

The selection of the material for the textile sheet will depend on a variety of factors. This is because additional functions beyond the mechanical stabilization of the films may be assigned to the woven fabric or the like, if required. For example, the fibers of the textile sheet may be conductive at least at their outside. In electrode layers or films prepared therewith, such textile sheets may additionally function as the current collector. While in accordance therewith, it is advantageous that a metal coated sheet will be used in the electrodes, it is preferred that in the electrolyte, use is made of an electronic non-conductor, for example of a preferably pure (organic and/or inorganic) polymeric object. Also suitable are glass or ceramics.

The fibers of the textile sheet may be prepared from plastics or using same. Such fibers are suitable in uncoated or coated form, wherein above all, metallizations are suitable as coatings. Commercially available and also useful in electrochemical components are for example woven fabrics made from polymers like PVDF, polyethylene, polypropylene or Teflon. In addition, such other plastics are suitable that may be used as a matrix material in the preparation of the paste-like masses for electrochemical components as outlined below in more detail and which may be processed into suitable textile materials and specifically into woven fabrics.

As mentioned, the textile sheets may be metallized in order to function as current collectors in electrode layers or films, in addition to the supporting function of the textile material. For this metallization, all those metals and electronic conductors are suitable which are stable in the respective electrochemical environment into which they are to be incorporated. Metallized woven fabrics are commercially available. Examples for suitable metallic coatings are aluminum, copper, nickel, but also alloys like stainless steel. Furthermore, it is possible in the preparation of such electrode layers or films to use textile sheets made from metallic fibers or threads. These may, for example, consist of any of those materials which have been previously mentioned as coating materials for the fibers or threads. Purely metallic textile sheets show the advantage of a better electronic conductivity compared to coated plastic materials, due to their higher amount of metal. It is specifically advantageous to use woven fabrics for such purposes. In contrast thereto, fibers made from carbon and specifically of graphite which are coated with metals as mentioned, are also suitable, although less advantageous. This is because it is to be expected that such fibers or threads will be brittle.

In contrast thereto it is advantageous to supply those layers or films which are suitable as electrolytes with non-conducting, uncovered woven fabrics or other sheet textiles of this kind, provided that such woven fabrics or other sheet textiles do not or only very little react with those components which are involved in the charge transport, for example lithium or respective electrolytes, in order to avoid the initiation of capacity losses specifically during formation. Not only but preferably in case non-conducting materials are used, the woven fabrics or the like are advantageously used having a layer thickness which is adapted to the thickness of the film. They should have a high pore volume, such that the reduction of the binder content in the films which has become possible by their use is not overcompensated by the volume of the textile material. Moreover, it should be borne in mind that the spaces or gaps between at least parts of the fibers are selected such that the dimension of the grains of the solid components in the paste is significantly smaller than that of the gaps. Otherwise, an incorporation of the pastes into the textile sheets would not be possible.

Preferably, the textile sheet is essentially a continuous component of the layer or film of the present invention.

The proportion of the binder material in the layers or films, i.e. of the polymeric material of the matrix, as well as that of the plasticizer which has been present in large amounts until now, may be minimized according to the measures of the present invention, which means that each of the said binder materials or plasticizers or even a combination thereof can be reduced to a proportion of 15% by volume, preferably of 10% by volume and less. Specifically preferred is a content of 6% by weight or less for each of the said components, very specifically preferred for their combination. Nonetheless, the mechanical stability of the films is fully retained. Optionally, plasticizer may not be used at all.

In order to provide sufficient electrical contact between the individual grains of the electrochemically activatable solid substance (B) that is embedded in the matrix (A), it is essential that the mass contains a sufficient amount of electrochemically activatable solid substance. Sufficient conductivity, or even very good conductivity are achieved in case the proportional volume of the electrochemically activatable solid substance is so high that it is approximately equal to the filled space in a theoretical close-pack. The minimum can vary somewhat depending on the materials used, since naturally parameters such as size and surface shape of the electrochemically activatable solid substance (B) obviously play a role. However, it is recommended that at least 60 volume % of solid substance (B) be used, preferably a minimum of about 65 volume %, and particularly preferably a minimum of about 70 volume %. The upper limit is not critical. Under certain circumstances, it will be possible to work into the paste-like mass up to 90 volume %, in exceptional cases even up to 95 volume %, of solid substance (B).

However, alternatively or in addition, it is also possible to achieve sufficient electrical contact between the grains of the solid substance (B) in that a second ionic and/or electronic conductor (or a homogeneous, mixed conductor, depending on the type of conductivity needed) (C) is used that is present as a thin layer, at least at the grain limits between (A) and (B).

The mass which shall be provided at least in the spaces or gaps within the textile sheet may be prepared as follows:

A plurality of materials can be used for the matrix (A). Systems containing solvents or solvent-free systems can be used. Solvent-free systems that are suitable are, for example, cross-linkable liquid or paste-like resin systems. Examples are resins made of cross-linkable addition polymers or condensation resins. For instance, pre-condensates of phenoplasts (novolak) or aminoplasts can be used that are finally cured into the layer of an electrochemical composite layer after the paste-like mass has been formed. Additional examples are unsaturated polyesters, such as polyester that can be cross-linked to styrene by graft copolymerization, epoxy resins that are curable using bifunctional reaction partners (for example bisphenol A epoxy resin, cold cured with polyamide), polycarbonates that can be cross-linked such as polyisocyanurate that can be cross-linked by a polyol, or binary polymethyl methacrylate, which can also be polymerized with styrene. A paste-like mass will be obtained which is formed from the more or less viscous precondensate or non-cross-linked polymer for matrix (A) or using essential components thereof, together with the component (B).

Another option is to use polymers or polymer precursors together with a solvent or swelling agent for the organic polymer. In principle there is no limit in terms of the synthetic or natural polymers that can be used. Not only can polymers with carbon main chains be used, but also polymers with heteroions in the main chain, such as polyamides, polyesters, proteins, or polysaccharides. The polymers can be homopolymers or copolymers. The copolymers can be statistical copolymers, graft copolymers, block copolymers, or polyblends, there is no limitation. In terms of polymers with a pure carbon main chain, natural or synthetic rubbers can be used, for instance. Particularly preferred are fluorinated hydrocarbon polymers such asteflon, poly(vinylidene fluoride) (PVDF) or polyvinyl chloride, since these make it possible to obtain particularly good water-repellant properties in the films or layers formed from the paste-like mass. This imparts particularly good long-term stability to the electrochemical elements thus produced. Additional examples are polystyrene or polyurethane. Examples of copolymers are copolymers of Teflon and of amorphous fluoropolymers, and poly(vinylidene fluoride)/hexafluoropropylene (commercially available as Kynarflex). Examples of polymers with heteroatoms in the main chain are polyamides of the diamine dicarboxylic acid type or of the amino acid type, polycarbonates, polyacetals, polyethers, and acrylic resins. Further materials include natural and synthetic polysaccharides (homeoglycans and heteroglycans), proteoglycans, for example, starch, cellulose, methylcellulose. In addition, substances such as chondroitin sulfate, hyaluronic acid, chitin, natural or synthetic waxes, and many other substances can be used. In addition, the aforesaid resins (precondensates) can be used in solvents and diluents.

One skilled in the art is familiar with solvents and swelling agents for the aforesaid polymers.

A plasticizer (also softener) can be present for the polymer or polymers used regardless of whether or not the matrix (A) contains a solvent or swelling agent. “Plasticizer” or “softener” should be understood to include substances whose molecules are bonded to the plastic molecules by coordinate bonds (Van der Waals forces). They thus diminish the interacting forces between the macromolecules and therefore lower the softening temperature and the brittleness and hardness of the plastics. In that, they are different from swelling agents and solvents. Due to their lower volatility, it is generally also not possible to remove them by evaporating them out of the plastic. Rather, they must be extracted using an appropriate solvent. Using a plasticizer effects high mechanical flexibility in the layer that can be produced from the paste-like mass.

One skilled in the art is familiar with suitable softeners for each of the plastics groups. They must be highly compatible with the plastic into which they are to be worked. Common softeners are high-boiling esters of phthalic acid or phosphoric acid, such as dibutyl phthalate or dioctyphthalate. Also suitable are, for instance, ethylene carbonate, propylene carbonate, dimethoxyethane, dimethylcarbonate, diethyl carbonate, butyrolactone, ethylmethylsulfon, polyethylene glycol, tetraglyme, 1,3-dioxolane, or S,S-dialkyldithiocarbonate.

If a combination of plastic and plasticizer is used for the matrix, the plasticizer can then be extracted from the paste-like mass using an appropriate solvent or by evaporation (e.g. under vacuum and/or increased temperature). The cavities that occur by this measure may be closed during subsequent pressure and laminating processes for combining the various layers. This improves the electrochemical stability of the charged accumulator. When a solid electrolyte is used in the described plastic matrix it is desirable to achieve ionic conductivity of at least 10⁻⁴S cm⁻¹.

Instead of later compressing the cavities, they can also be filled with a second solid or liquid electrolyte or electrode material once the plasticizer has been extracted.

As stated in the foregoing, the present layers according to the invention are suitable for a plurality of electrochemical elements, such as accumulators, electrochromic indicating elements, and especially rechargeable electrochemical cells on a solid body basis. One skilled in the art can select the same solid substances (B) for them that he would use for classic electrochemical elements, that is, substances to which no plastics have been added.

The following solid substances (B) are examples of options that can be used for lithium-technology accumulators:

| | |
|---|---|
| lower contact electrode | Al, Cu, Pt, Au, C |
| positive electrode | LiF, LiₓNiVO₄, Liₓ[Mn]₂O₄, LiCoO₂, |
| | LiNiO₂, LiNi_{0.5}Co_{0,} ₅O₂, |
| | LiNi_{0.8}Co_{0.2}O₂, V₂O₅, LiₓV₆O₁₃ |
| electrolyte | Li_{1.3}Al_{0.3}Ti_{1.7}(PO₄)₃, |
| (solid body, in this case) | LiTaO₃ · SrTiO₃, LiTi₂(PO₄)₃ · LiO, |
| | LiH₂(PO₄)₃Li₂O, Li₄SiO₄Li₃PO₄, |
| | LiX + ROH where X = Cl, Br, I |
| | (1, 2 or 4 ROH per LiX), |
| negative electrode | Li, Li_{4 + Ti}₅O₁₂, LiₓMoO₂, LiₓWO₂, |
| | LiₓC₁₂ , LiₓC₆, lithium alloys |
| upper contact electrodes | Al, Cu, Mo, W, Ti, V, Cr, Ni |

However, of course, the present invention is not limited to lithium-technology accumulators, but rather, as stated in the foregoing, includes all systems that can be produced using “conventional” technology, that is, without working in an organic polymer matrix.

The following describes a few special embodiments of the paste-like masses that are suitable for special components (elements) or element parts. For those electrochemically activatable parts that are not prior art, it should be clear that these substances can also be used in “bulk form”, i.e., without the polymer matrix in appropriate electrochemical elements or components.

Appropriately selecting the electrochemically active substances makes it possible to produce electrochemical elements, such as accumulators, whose characteristics in the charge/discharge curves make it possible to control the charge/discharge status of the accumulator. Thus mixtures of two of the electrode materials cited in the forgoing, or of other appropriate electrode materials, can be used for the electrochemically activatable solid substance (B) for the positive or negative electrodes, the mixtures having different oxidation and reduction stages. Alternatively one of the two substances can be replaced with carbon. This leads to characteristic segments in the charge/discharge curves that make it possible to advantageously detect the charge or discharge status of an accumulator produced using such masses. The curves have two different plateaus. If the plateau that is near the discharge status is achieved, this status can be indicated to the user so that he knows that he will soon need to recharge, and vice versa.

If carbon and an element that can be alloyed with lithium are worked into a paste-like mass provided for a negative electrode, this imparts to the electrode that can be produced therefrom (with properties of an alloy electrode or intercalation electrode) a particularly high capacity that has improved electrochemical stability. In addition, the expansion in volume is lower than in a pure intercalation electrode.

Furthermore, graphite or amorphous carbon (carbon black) or a mixture of the two can be worked into the paste-like mass, together with an electrode material for a positive or negative electrode. Particularly advantageous in this regard are weight proportions of 20 to 80% by weight amorphous carbon relative to the electrochemically activatable component. If the mass is provided for a positive electrode, the lubricating effect of the carbon is an advantageous property that improves the mechanical flexibility of a layer produced from the paste-like mass. If the mass is provided for a negative electrode, the electrochemical stability and electronic conductivity are improved in addition, as has been described in the foregoing.

The inventive paste-like mass can also be used for electrodes other than intercalation electrodes. One example of this is the use of metal powder combined with an alkali or earth alkali salt as the electrochemically activatable solid substance (B). A paste-like mass produced with this combination can be used to produce decomposition electrodes. The expansion in volume that is typical for intercalation electrodes does not occur in this case, which leads to improved service life over time. An example of this is combining copper and lithium sulfate.

A very particular electrode variant can be obtained when the electrode material (B) is a metal that does not react with lithium and that further contains a lithium salt. The matrix (A) in this variant is produced as described in the foregoing from a combination of plastic with a plasticizer that is later extracted from the paste-like mass. In this variant, however, the cavities that then occur are not subsequently closed under pressure or the like during later lamination of the electrochemically activatable layers. On the contrary, care is to be taken that they remain open. When combined with a lithium salt in the adjacent electrolyte layer, an electrode thus comprised has the property of being able to reversibly incorporate and remove lithium in the cavities that occur. It has the advantages of an intercalation electrode, but avoids the disadvantages of such an electrode (for example, expansion in volume) and has excellent electrical properties due to the large interior surface. An example of a metal that does not react with lithium is nickel.

Surprisingly it has also been demonstrated that working a phase mixture into the inventive paste-like mass, comprising Li₄SiO₄.Li₃PO₄, regardless of the intended electrochemical application of said mass, leads to an improvement in the plasticity of the electrodes or solid electrolyte produced therefrom. This requires that the phase mixture be ground extremely fine. The extremely small grain sizes should be the reason for improved internal sliding effect.

Regardless of whether the solid substance (B) is an electrode material or an electrolyte material, it can comprise a lithium ion conductor and one or more additional ion conductors (e.g. for Li, Cu, Ag, Mg, F, Cl, H). Electrodes and electrolyte layers made of these substances have particularly favorable electrochemical properties such as capacity, energy density, mechanical and electrochemical stability.

In one embodiment of the present invention, the paste-like mass of the present invention to be incorporated into the sheet may additionally contain a second solid ion, electron, and/or mixed conductor (C), as mentioned above. The latter can be worked into the matrix in different ways. If it is an ion conductor that is soluble in a solvent (such as the solvent in which the matrix material (A) is also soluble), the paste-like mass can be produced in that the solvent for the matrix material contains this second ion conductor. The vapor pressure of the solvent must be high enough that it can be extracted or can evaporate in a subsequent stage (for example after the components of the mass are thoroughly mixed, if the mass also has a paste-like consistency in the absence of any solvent, or after producing the layer or film). When in such an embodiment of the invention a plasticizer is also present, it is possible to select a plasticizer that is also soluble in the solvent and that subsequently can also be removed using said solvent. This embodiment of the invention can also be produced with conductors (C) that have relatively poor conductivity (especially ion conductivity, if the intent is to have this property).

In a further embodiment of the invention, an ion, electron, or mixed conductor (C) may be selected that is soluble in the plasticizer that is selected for the system. In this case, the plasticizer should have a relatively low vapour pressure. When component (C) dissolved in plasticizer is thoroughly mixed with the other components of the paste-like mass this produces a modified grain limit between the conducting components, the limit having a certain plasticity. In this embodiment of the invention, the conductivity of the electrochemically activatable solid substance (B) must clearly not be as high as that of an electrochemically activatable solid substance (B) that constitutes the sole electrochemically relevant component of the mixture. In this variant, quaternary lithium ion conductors, such as Li₄SiO₄.Li₃PO₄, Li₄SiO₄.Li₂SO₄, or Li₄SiO₄.Li₅AlO₄, can be used for component (B) that combine ionic conductivity on the order of magnitude of 10⁶ S/cm with a high stability range. The plasticity of the grain limits can be caused to increase further, if, in addition, a substance with high vapor pressure (for example ether or dimethoxethane for plasticizers like dibutyl phthalate) is worked into the paste-like mass. In this case the solvent acts as a modifying agent for the plasticizer. Such an embodiment is possible, for example, if the matrix contains or essentially comprises PVC or PVDF or other halogenated hydrocarbon polymers.

If the conductor (C) is an ion conductor, it is possible to use a hygroscopic salt for it. In this embodiment of the invention, the ion conductor (C) is worked into the paste-like mass in an anhydrous or lower water form. Water is absorbed during processing (or by subsequent storage in a humid environment). This results in a grain limit for this ion conductor that has a certain plasticity. If the hygroscopic ion conductor is able to form crystalline hydrates, the deposit of the diffusing water as crystallized water into a fixed grain size can cause an expansion in volume that creates improved grain limit contact, and the weaker bond of the conducting ion to the surrounding hydrate envelope also improves the ionic conductivity of the electrolyte (the cation of the electrolytes can move in its polar envelope to a certain degree). An example of a salt that can be used in this manner is LiNO₃.

If a salt that is insensitive to hydrolysis is used for conductor (C), for example a lithium salt selected from among perchlorate, the halogenides (X═Cl, Br, I), nitrate, sulfate, borate, carbonate, hydroxide, or tetrafluoroborate, especially for producing a solid electrolyte, the paste-like mass as well as the electrochemically activatable layer to be produced therefrom can be produced in an advantageous manner in an ambient atmosphere.

The mass which has been prepared as described above should in most cases be of a paste-like consistency until it has been incorporated into the textile sheet. For its production, the components can be mixed in a conventional manner, preferably by vigorously agitating or kneading the components. If necessary, the organic polymer or its precursors are pre-dissolved or pre-swollen in the solvent or swelling agent before the component (B) is added. In a particularly preferred embodiment of the invention, the mass is subjected to ultrasonic treatment during the mixing process or thereafter. This causes the solid substance (B) and the conductor (C), if any, to pack more densely because the grains break up and thus decrease in size. This improves the electrical and electrochemical properties of the paste-like masses. The materials provided for the electrodes or electrolytes can also be subjected to such an ultrasonic treatment prior to being worked into the mass in order to reduce the size of the grains at the beginning of the process.

The such prepared pastes or paste-like masses are the paste-like starting materials to be incorporated into the textile sheets. For the incorporation of the pastes into the sheets, a variety of technical processes may be used which are known in the art. The following examples shall be mentioned: (a) dipping or immersion processes during which the woven fabric or the like is dipped or immersed into the paste and then is drawn out therefrom in a controlled way. During this procedure, the paste adheres to the sheet. By controlling the drawing speed and adjusting the viscosity of the paste, the layer thickness remaining on the woven textile may be adjusted; in addition, the layer thickness may be varied by multiple immersion; (b) printing procedures using rotating drums, i.e. reverse roll coating; (c) casting procedures whereby the paste is pressed into the textile sheet in the desired thickness layer, for example by means of dye-casting; (d) the pastes are first drawn into films which are subsequently laminated into the textile sheets using pressure and increased temperature. In all these cases, it is important that the mass completely fills the spaces or gaps between the fibers within the textile sheet.

Due to the embedding of the solid substances (B) into the matrix (A) as well as the incorporation thereof into the supporting textile sheet, there is no need of sintering the powdered electrochemically activatable substances at high temperatures, as is customary for “conventional” electrochemical elements. Such sintering would not allow the formation of films.

The inventive paste-like masses and films are especially suitable for producing thin-film batteries and other similar electrochemical elements such as electrochromic components or elements. Preferably these are elements in so-called “thick-film” technology. The individual layers of these elements are also called “tapes”. Individual electrochemically active or activatable layers are produced in thicknesses from approximately 10 μm up to approximately 1 to 2 mm, placed upon one another, and brought into intimate contact. One skilled in the art will select the thickness appropriate for the application. Ranges are preferably from approximately 50 μm to 500 μm; especially preferred is a range of approximately 100 μm. However, in accordance with the invention it is also possible to produce corresponding thin-film components or elements (this term includes thicknesses of preferably 100 nm to a few μm). However, this application may be limited because corresponding elements will not satisfy current requirements in terms of capacity in a number of cases. However, it is conceivable that the application could be used for back-up chips, for instance.

The present invention therefore includes electrochemically active or activable layers that can be produced from the paste-like masses described in the foregoing that are self-supporting or that are placed on a substrate, preferably in the thicknesses indicated. The layers are preferably flexible.

For producing both the self-supporting layers (films, tapes) and layers that can be placed on a substrate, methods known in prior art can be used that are suitable for the appropriate polymeric materials of the matrix. The consolidation of the paste-like masses then occurs, depending on the material, by curing (of resins or other precondensates), by cross-linking prepolymerisates or linear polymerisates, by the evaporation of solvent, or in a similar manner.

In a preferred embodiment of the invention, cross-linkable resin masses (pre-condensates) are used as described above for the paste-like masses, and are cured by UV or electron radiation once the layer has been formed. Curing can of course also be thermal or chemical (for example by immersing the produced layer in an appropriate bath). If necessary, suitable initiators or accelerators or the like are added to the masses for the cross-linking.

The present invention furthermore relates to composite layers with electrochemical properties, especially accumulators and other batteries or electrochromic elements, most preferably rechargeable electrochemical cells that are formed by or include a corresponding sequence of the aforesaid layers.

FIG. 1 illustrates the sequence of such an arrangement in which the electrodes as well as the electrolyte are embedded in a woven fabric by which they are strengthened. The reference numerals are: lead electrode (contact electrode) 1, intermediate tape 2, electrode 3, strenghtened by woven fabric, electrolyte 4, strenghtened by woven fabric, and counter-electrode 5, strenghtened by woven fabric. First, the respective paste-like masses are incorporated into the gauze or netting as described above, and subsequently, the composite layer is prepared. It may be seen from the figure that the mass made from the polymer matrix and the solid material for the electrolyte or the electrode, respectively, may extend beyond the above and the below surface of the textile sheet, forming a continuous layer thereon. However, this is not a necessary feature of the invention; it is sufficient if the mass fills the spaces and gaps within the textile sheet up to about the level of its surfaces, the threads present on the outside of the textile material being covered by the mass or not. Optionally, one side of the layer may be as shown in the figure, while the other remains uncovered or is covered with an only very thin layer of the mass.

The three-layered cell as described (or any other electrochemical component consisting of positive electrode/electrolyte/negative electrode) may additionally be provided with lead or contact electrodes (layers 1 in FIG. 1). This is specifically the case when the woven fabric within the electrode layers is not electrically conductive.

Each layer or film can be individually converted into its final consolidated state. If these are self-supporting layers or films, the appropriate components of the element to be formed can subsequently be joined together by lamination. Conventional laminating techniques can be used for this. These include, for example, extrusion coating, whereby the second layer is bonded to a carrier layer by pressure rollers, calender coating with two or three roll nips, wherein the substrate web runs in in addition to the paste-like mass, or doubling (bonding under pressure and counterpressure of preferably heated rollers). One skilled in the art will not have any problem finding the techniques that are appropriate depending on the selection of the matrices for the paste-like masses.

A pressure process during the bonding (lamination) of the individual layers can frequently be desirable, not only for improved bonding (and therefore for achieving improved conductivity) of the individual layers, but also, for instance, in order to eliminate any cavities that are present in the individual layers that had been produced, for instance, by washing out the plasticizer or the like, as described in the foregoing. Current techniques can be used for this. Cold pressing (at temperatures below 60° C.) can be advantageous if the materials used permit this. This provides particularly good contact among the individual layers.

In an advantageous embodiment of the invention, the layers which have been prepared as described may be impregnated with an electrolyte solution (e.g. a lithium salt dissolved in an organic solvent like propyl carbonate and/or ethyl carbonate or the like) prior to or after lamination. Such electrolyte solutions are known to the skilled man of the art and are in some cases commercially available.

The electrochemical parts that can be produced with the inventive paste-like masses are not limited. It is therefore understood that the embodiments described in the following are merely examples or particularly preferred embodiments.

Thus, rechargeable electrochemical cells can be produced in thick-layer technology, i.e., with individual electrochemically activatable layers in a thickness of approximately 10 μm up to approximately 1 to 2 mm and preferably approximately 100 μm. If the electrochemical cell is to be based on lithium technology, the solid substances for the electrodes or electrolyte layers can be those substances that have already been enumerated in the foregoing for this purpose. At least three layers have to be provided, namely, one that functions as a positive electrode, one that functions as a solid body electrolyte, and one that functions as the negative electrode, i.e., layers 3, 4, and 5 in FIG. 1.

If metal coated textile sheets are used in the electrodes, for example metallized woven fabrics, the electric contacts may be guided from the battery body through the metallized plastic housing to the outside, which is specifically advantageous. The packaging of such a battery will usually be in a metallized plastic film which will completely enclose the battery body. The junctures of the packaging are closed by heat sealing. With this step, the contact tags of the battery body are guided through the sealing juncture and are welded therein during heat sealing. The sealing of the contact tabs which are usually extending through the sealing juncture as thin metal strips is a process the technique of which is only poorly controlled since during strong sealing, the sealing material is displaced above the contact tabs, which results in short-circuits via the metallization of the plastic sealing film. On the other hand, if only poor sealing is performed, the sealing juncture will possibly comprise a leakage point, since the sealing material will insufficiently flow around the contact tabs. If, according to the invention, the contact tabs are part of the textile sheet extending through the sealing juncture to the outside, the sealing material will be well distributed within the woven fabric or the like of the sheet, and a plating-through will be avoided while at the same time, the sealing juncture above the passages will be closed. For this purpose, the sheet should preferably be pressed to a thickness of significantly below 100 μm in the area of the contact tabs, in case its thickness is originally larger. This feature may be obtained for example with suitable woven fabrics. Moreover, it is possible to incorporate sealing material into the woven fabric in the area of the passage of the contact tab through the sealing juncture prior to the sealing step, using for example a dispenser in order to improve sealing performance. Due to the shape or structure of the woven fabric, the sealing material will adhere thereto especially well, in contrast to its application onto metal tapes.

FIG. 2 shows an electrode film 1 comprising a metallized woven fabric embedded therein. In the area of the contact tab 2, the woven fabric has been pressed into the required reduced thickness for its passage through the sealing juncture. Also in this embodiment, the presence of a continuous layer of the mass prepared from polymer matrix and electrochemically activatable solid material above and/or below the textile sheet as shown in the figure is of course not mandatory.

The following examples shall illustrate the invention in more detail.

### EXAMPLE 1

For the preparation of a positive electrode, 2 g of PVDF-HFP are combined with 1 g of ethylene carbonate and 100 g acetone. Next, 14 g LiCoO₂ and 3 g of conductive carbon black are added as a fine powder. These components are subsequently thoroughly mixed by vigorous agitation. Into this paste, a commercially available woven fabric is immersed which is coated with aluminum. The thickness of the woven fabric is 150 μm. After the woven fabric has been drawn out of the paste in a controlled way, it is filled with said paste. The filled woven fabric is subsequently dried and again immersed. By alternate drying and immersion, the desired thickness of the layer may be adjusted. A stable and highly flexible film is obtained which is used as a positive electrode in a lithium based accumulator.

### EXAMPLE 2

A negative electrode is prepared in that a woven fabric coated with copper and having a thickness of 150 μm is alternately immersed and dried. The paste was prepared as follows: 2 g of PVDF-HFP were thoroughly mixed by agitating with 1 g of ethylene carbonate and 100 g of acetone. Subsequently, 15 g of battery graphite and 2 g of conductive carbon black were added in the form of fine powders. After additional thorough mixing, the paste had formed into which the woven fabric was introduced.

### EXAMPLE 3

An electrolyte film may be formed by incorporating a paste into a woven fabric. The paste is prepared by thoroughly mixing 2 g PVDF-HFP with 1 g of ethylene carbonate and 100 g of acetone and the subsequent addition of 17 g finely grained Li_{1,3}Al_{0,3}Ti_{1,7}(PO₄)₃. The woven fabric was a transparent material coated with PTFE and having a thickness of 75 μm.

### EXAMPLE 4

Using the films of the examples 1 to 3, an accumulator based on lithium technology was prepared by laminating the films into a composite layer using pressure and increased temperature. For this purpose, a so-called bicell was constructed wherein the material of the negative electrode was present on both sides of the copper coated woven fabric. To both sides of this tape, woven fabric coated with electrolyte according to example 3 was laminated at a lamination temperature of 130° C. and a pressure of 2 MPa. Onto both sides of this structure, woven fabric coated with positive electrode material was laminated at 130° C. and again a pressure of 2 MPa. This component representing an accumulator was subsequently packed into a plastic film coated with aluminum. Prior to final sealing, the accumulator film laminate was impregnated with commercially available electrolyte solution LP 50 by Merck in order to improve the ionic conductivity within the film laminate. The contact tabs were realized by a metallized woven fabric which had been compressed to a thickness of about 60 μm. For the bonding of the accumulator with a consuming device, the tabs were guided through the sealing juncture of the packaging film to the outside.

A test cell which had been prepared according to example 4 was subjected to charging/discharging within a battery test system. First, charging was performed up to 4,2 V using a constant charging current, and then a decreasing charging current was modulated at a constant voltage. Subsequently, the cell was discharged down to 3 V at a constant current. FIG. 3 shows the diagram resulting from such a charging and discharging cycle. FIG. 4 shows the decrease of the initial capacity depending on the number of cycles.

1. Electrochemically activatable layer or film for use in electrochemical elements, comprising:
(a) a textile sheet and
(b) a mass made of at least
(A) a matrix containing or consisting of at least one organic polymer, a precursor thereof or a prepolymer thereof, and
(B) an electrochemically activatable inorganic material that is not soluble in said matrix and that is in the form of a solid substance
which is at least present in the gaps of the textile sheet.

2. Electrochemically activatable layer or film according to claim 1, characterized in that it may be used as a cathode or an anode and in that the textile sheet consists of a metallized plastic material or of metal.

3. Electrochemically activatable layer or film according to claim 1, characterized in that it may be used as an electrolyte layer and in that the textile sheet consists of an organic or inorganic-organic polymer material, glass or ceramics.

4. Electrochemically activatable layer or film according to claim 2 or 3, characterized in that the textile sheet is a flexible woven fabric.

5. Electrochemically activatable layer or film according to any of the preceding claims, characterized in that the organic polymer of the matrix (A) is a swellable and/or chlorinated or fluorinated polymer, preferably polyvinylidene chloride, polyvinylidene fluoride, polyethyleneoxide or a copolymer of polyvinylidenfluoride and hexafluorpropylene or a polymer mixture containing at least one of these polymers.

6. Electrochemically activatable layer or film according to claim 5, characterized in that it optionally comprises a plasticizer, the proportion of which in the layer or film is not more than 15% by volume, preferably 0-3% by volume.

7. Electrochemically activatable layer or film according to any of the preceding claims, characterized in that the proportion of polymer material of matrix (A) within the layer or film is not more than 15% by volume, preferably not more than 6% by volume.

8. Composite layer having electrochemical properties, comprising an electrochemically activatable layer or film according to any of the preceding claims which is suitable as a cathode and/or an electrochemically activatable layer or film according to any of the preceding claims which is suitable as an electrolyte layer and/or an electrochemically activatable layer or film according to any of the preceding claims which is suitable as an anode.

9 Rechargeable electrochemical cell, comprising a composite layer according to claim 8.

10. Rechargeable electrochemical cell according to claim 9, characterized in that the electrochemically active layers or films are enclosed within a housing and that the cathode layer and the anode layer each comprises a metallized sheet which extends beyond the area of the cathode and the anode, respectively, and which is guided through the wall of the housing into the outside, forming a contact tab.

11. Rechargeable electrochemical cell according to claim 10, characterized in that the housing consists of a metallized plastic film which is sealed by sealing junctures and in that the contact tabs are guided through the sealing junctures to the outside.

12. Method for producing an electrochemically activatable layer or film according to any of claims 1 to 7, comprising the following steps:
preparing a paste-like mass from at least
(A) a matrix containing or consisting of at least one organic polymer, a precursor thereof, or a prepolymer thereof, and
(B) an electrochemically activatable inorganic material that is not soluble in said matrix and that is in the form of a solid substance,
filling at least the gaps of the textile sheet with the paste-like mass, and
solidifying the paste-like mass into a layer or flexible film.

13. Method according to claim 12, characterized in that the textile sheet is once or more than once immersed into the paste-like mass and drawn back therefrom in a controlled manner, such that at least the gaps of the textile sheet are filled with the paste-like mass.

14. Method according to claim 12, characterized in that the textile sheet is coated with the paste-like mass using a printing technique and rotating drums, whereby the mass penetrates the gaps of the textile sheet.

15. Method according to claim 12, characterized in that the paste-like mass is pressed into the gaps of the textile sheet by dye-casting.

16. Method for producing an electrochemically activatable layer or film according to any of claims 1 to 7, comprising the following steps:
preparing a paste-like mass from at least
(A) a matrix containing or consisting of at least one organic polymer, a precursor thereof, or a prepolymer thereof, and
(B) an electrochemically activatable inorganic material that is not soluble in said matrix and that is in the form of a solid substance,
solidifying the paste-like mass into a layer or flexible film,
laminating of the textile sheet into the solidified layer or film using pressure and/or heat.
